(19) United States
(12) Patent Application Publication
(10) Pub. No.: US 2005/0240385 A1
(43) Pub. Date: Oct. 27, 2005

(54) System and method for determining radius of gyration, molecular weight, and intrinsic viscosity of a polymeric distribution using gel permeation chromatography and light scattering detection

(75) Inventors: Rong Xie, Hudson, MA (US); Yefim Brun, Wilmington, DE (US); Marc C. Gorenstein, Needham, MA (US)

Correspondence Address: Anthony J. Janiuk;Waters Corporation, 34 Maple Street, Milford, MA, 01757, US

(73) Assignee: WATERS INVESTMENTS LIMITED, Milford, MA (US)

(21) Appl. No.: 10/829,848

(22) Filed: Apr. 22, 2004

(51) Int. Cl. G06G 7/48; G06G 7/58

(52) U.S. Cl. 703/11

(57) ABSTRACT

A system and method for analyzing data from a gel permeation chromatography (GPC) or size exclusion chromatography (SEC) system fro determining a polymeric sample's radius of gyration. Data from two or more detectors is used with a least-squares minimization fit. A novel method includes the simultaneous determination of a sample's radius of gyration using data from a light scattering detector that collects data from at least two incident angles. Detectors within the inventive method include a multi-angle light scattering (LS) detector, viscometer (V) and a refractive index (RI) detector.

### CROSS REFERENCE TO RELATED APPLICATIONS

This application claims benefit of U.S. Provisional Application No. 60/335,254, filed Oct. 23, 2001 (Attorney Docket No. WAA-279) and International application No. PCT/US02/33945, filed Oct. 23, 2002 (Attorney Docket No. 19921/58-PCT). The contents of each of the aforementioned applications are hereby expressly incorporated herein by reference in their entirety.

### STATEMENT ON FEDERALLY SPONSORED RESEARCH

N/A

### FIELD OF THE INVENTION

The present invention relates to analysis of data from gel permeation chromatography (GPC) instrumentation, and more particularly to a computer system and method for analyzing data to determine radius-of-gyration, as well as absolute molecular weight and intrinsic viscosity of a polymeric distribution.

### BACKGROUND OF THE INVENTION

The molecular structure of a synthetic polymer determines its end-use and its process characteristics, such as hardness, tensile strength, drawability, elastic modulus, and melt viscosity. Important determinants that define the molecular structure of synthetic polymers include the chemical nature of their repeating units, their molecular weight distribution, their molecular topology (branching), and their conformation law.

In a GPC separation, a molecule's effective size, not its molecular weight per se, determines its elution volume. For example, two polymers may have the same molecular weight, but may differ in composition or branch topology. Such differences can lead to different elution volumes. Elution volume by itself determines a molecular weight distribution in a relative, not an absolute sense.

The separation of a polymer sample by gel permeation chromatography (GPC) followed by detection is a fundamental technique by which to infer these intrinsic properties of a polymeric distribution. Another term used for GPC is size exclusion chromatography (SEC). This technique allows one to determine the molecular weight distribution (MWD), the intrinsic viscosity law (IVL), and the conformation law (CL) of a polymeric sample. The conformation law (CL) of a polymeric sample is the molecules' radius of gyration (r_{g}) distribution versus molecular weight. Both the IVL and CL give important information relating to branching properties and the conformation of the molecules. The accuracy and the precision of the estimation of the MWD, the IVL, and the CL depend not only on the quality of the data obtained from the chromatographic system, but also on the details of the data analysis methodology. Thus, data analysis methods become an essential element in the GPC analysis of polymers.

At evenly spaced time intervals, each detector records a measurement of the properties of the separated sample as it elutes from the column and passes through a detector's flow cell. Each measurement, averaged over a narrow time range, corresponds to a narrow range in the sample's molecular weight distribution. The molecular weight range corresponding to a measurement recorded at a single time interval is referred to as a “slice”.

A slice therefore refers to measurements that are obtained by sampling the detector responses at elution time tᵢ. A slice can be referenced by its slice number i, its elution time tᵢ, or its elution volume Vᵢ. Typically, elution volume is obtained by multiplying the elution time of a slice by the nominal flow rate of the pump.

The radius of gyration r_{g} of a molecule is the root-mean-squared radius averaged over all conformations. The quantity r_{g}(Vᵢ) is the radius of gyration of a molecule at slice i. The quantity r_{g}(Vᵢ) needs to be determined for each slice over the whole peak region in order to determine the conformation law of a polymeric sample.

The size of the molecule, as measured by its r_{g}, affects how the intensity of scattered light changes as a function of the scattering angle at which the scattered intensity is measured. Thus the measurement of r_{g}(Vᵢ) is obtained from analysis of the data obtained from a light-scattering (LS) detector.

The prior art analysis first obtains the radius of gyration r_{g,i}≡r_{g}(Vᵢ) independently from each slice. Model curves can then be fit to these values r_{g,i} in order to obtain additional results.

The analysis of the prior art starts with the LS data and calculates r_{g,i}, for each slice by fitting the scattering law to the scattered intensities measured at each scattering angle ΔRᵢ(θⱼ). From the fitted scattering law, the algorithms of the prior art compute radius of gyration r_{g,i} from the fit at slice i and extrapolate the fit to obtain the Rayleigh ratio at zero angle ΔRᵢ⁰≡ΔRᵢ(0). This analysis is carried out typically by optimizing a χ² using the data of all the angles obtained at that slice:

$${χ}_{i}^{2} = {\sum }_{j} {[ Δ {R}_{i , j} - Δ {R}_{i}^{0} \cdot P ( {k}^{2} {r}_{g , i}^{2} {sin}^{2} \frac{{θ}_{j}}{2} ) ]}^{2} \qquad Eq . ( 1 )$$

where

$$k = \frac{4 π {n}_{s}}{λ}$$

and, and where P is the model-dependent scattering form factor. Note that only light-scattering data participate in the calculation. In the above formula, the value for the radius of gyration is adjusted for each slice to obtain the fitted value r_{g,i} for each slice. It will be convenient to define

$${P}_{i , j} ≡ P ( {k}^{2} {r}_{g , i}^{2} {sin}^{2} \frac{{θ}_{j}}{2} )$$

as the optimized, post fit, value for the scattering form factor for slice i and angle j that is obtained form the LS data. Once ΔRᵢ⁰ and r_{g,i} are known, the prior art methods can determine the following.

(i) LS-Only:
ΔRoᵢ—Zero-angle Rayleigh ratio at i-th slice
r_{g,i}—Observed radius of gyration at i-th slice

Based on the above extrapolated zero-angle slice Rayleigh ratio and observed radius of gyration of the distribution, we can calculate two molecular weight moments (of the polymeric distribution) using only the light-scattering results. These moments are the weighted molecular weight average and z-average radius of gyration:

$$\begin{matrix}MwLS ≡ {M}_{w} = \frac{F \cdot Δ T}{m \cdot K} {\sum }_{i} Δ {Ro}_{i} & Eq . ( 2 ) \\ Rgz ≡ < r {>}_{z} = \frac{{\sum }_{i} Δ {Ro}_{i} \cdot {Rg}_{obs , i}}{{\sum }_{i} Δ {Ro}_{i}} & Eq . ( 3 )\end{matrix}$$

(ii) LS-RI/UV Dual-Detection:
If we combine LS data with RI data, which consists of the concentration data and dn/dc, the following “observed” slice values can be calculated:

$${M}_{obs , i} = \frac{{Ro}_{i}}{{K}_{LS} {v}^{2} {c}_{i}} \\ Observed molecular weight at i \text{-} th slice where \\ v ≡ \frac{ⅆ n}{ⅆ c} \qquad Eq . ( 4 )$$

If LS data and the RI data are combined with an external hydrodynamic calibration (as obtained from narrow standards), then we arrive at the modified universal calibration GPC-LS case. From the external universal calibration, the “observed” slice intrinsic viscosity can be calculated from hydrodynamic volume H_{ext,i} without actually having viscosity data:

$${[ η ]}_{obs , i} = \frac{{H}_{ext , i}}{{M}_{obs , i}} \\ Observed intrinsic viscosity at i \text{-} th slice \qquad Eq . ( 5 )$$

(iii) LS-RI/UV-IV Triple-Detection:
If LS and RI data are combined with viscosity data, slice intrinsic viscosity is calculated from the given slice (“observed”) specific viscosity η_{sp,I}:

$${[ η ]}_{obs , i} = \frac{{η}_{sp , i}}{{c}_{i}} \\ Observed intrinsic viscosity at i \text{-} th slice \qquad Eq . ( 6 )$$

Then the “observed” slice hydrodynamic volume can be calculated:
H_{obs,i}=M_{obs,i}[η]_{obs,i} Observed hydrodynamic volume at i-th slice Eq. (7)
Special Cases:

(i) One Light-Scattering Channel:

With measurements made at only a single scattering angle, r_{g} cannot be calculated. Thus, to obtain estimates of sample properties, we must set zero-angle Rayleigh ratio ΔRo_{I} to the raw Rayleigh ratio of that single channel:
ΔRoᵢ=ΔR_{i,0}

(ii) Two Light-Scattering Channel:
Instead of performing a non-linear fit, the extrapolation is done by solving the following equation:

$$Δ {R}_{i , j} = Δ {Ro}_{i} \cdot P ( {k}^{2} {Rg}_{i}^{2} {sin}^{2} \frac{{θ}_{j}}{2} ) for j = 0 , 1 \qquad Eq . ( 8 )$$

Once these slice values are determined, additional fits can be performed to determine intrinsic properties of the polynomical distribution such as the IVL and CL. However, these fits, since they are applied to slice values are affected by the large errors in the tails of the distribution that will occur with slice value.

The prior art calculation of r_{g} in more detail

The radius of gyration needs to be determined for each slice over the whole peak region. Detector noise present in the measured values of the Rayleigh ratios ΔR_{i,j} introduces error in all quantities derived from them. Of particular concern in the estimation of the radius of gyration. It is important to obtain a smooth representation of the radius of gyration as a function of volume, since result is used in subsequent, noise-sensitive calculations.

If r_{g} is determined by the slice-independent method of the prior art, then these errors in r_{g} increase as the values ΔR_{i,j} decrease in the tails of the peak. The method of the prior art attempts to reduce the error in r_{g,i} by fitting low-order polynomials, as a function of slice number or elution volume, to these sliced-determined value.

The calculation for an individual slice fits the Rayleigh ratios of all angles to a scattering model to obtain the Rayleigh ratio at zero angle, as well as the radius of gyration. In the prior art, a fit is made to each slice using only the data of all the angles at individual slice. Typically this fit is made by optimizing the following expression for:

$${χ}_{i}^{2} = {\sum }_{j} {[ Δ {R}_{i , j} - Δ {R}_{i}^{0} \cdot P ( {k}^{2} {r}_{g , i}^{2} {sin}^{2} \frac{{θ}_{j}}{2} ) ]}^{2} \qquad Eq . ( 9 )$$

where

$$k = \frac{4 π {n}_{s}}{λ}$$

and P is the model-dependent scattering form factor. Only light-scattering data are involved in this calculation; no use is made of RI or V data. The result of this calculation is r_{g,i}.

In the method of the prior art, it is these values of r_{g,i} that are input to successive calculations. For example a polynomial model, such as

$$log {r}_{g} ( V ; {P}_{m} ) = {\sum }_{m} {P}_{m} {V}^{m}$$

(or, equivalently,

$${r}_{g} ( V ; {P}_{m} ) = {10}^{\sum {P}_{m} {V}^{m}} \text{)}$$

could be introduced, where Pₘ is the array of polynomial coefficients. It is this model that will be needed to determine (in concert with other data) the calibration law r_{g}(M) of the polymeric distribution.

Unfortunately, the method of the prior art has a problem of fitting the model

$$log {r}_{g} ( V ; {P}_{m} ) = {\sum }_{m} {P}_{m} {V}^{m}$$

in the tails of a polymer distribution, where the signal-to-noise ratio is low.

A major problem in the analysis of data is that the noise present in the detector responses introduces errors in the quantities computed from slice measurements. Each of the known detectors employed for GPC contains non-idealities in their responses. Typically, these non-idealities fall into two categories, baseline drift and stochastic detector noise. Detector noise can also be referred to as system noise. Baseline drift in a thermally stabilized chromatograph is accurately compensated for by baseline correction procedures.

Detector noise is an irreducible component of the measurement process. The origin of this noise, seen as fluctuations in the baseline, is the result of several fundamental phenomena. One is the shot noise of the light sources such as in RI and LS detectors. Other origins are thermal noises associated with amplifiers in all detectors; fluctuations in the pump flow rate; and thermal variations. Particulate, contaminants, and bubbles can also add additional noise components to the signal.

The net result of these effects is manifested in stochastic noise added to each slice measurement. Such additive noise has zero mean and a well-defined standard deviation. The standard deviation of the noise will in general be different for the different detectors, but each detector's noise is constant throughout the separation.

The effect of the detector-noise-induced error in the slice-measurements is to introduce error in the quantities log (Rᵢ/cᵢ) and log (η_{sp,i}/cᵢ) Because cᵢ is in the denominator, the noise in these quantities increases as the response in the concentration profile decreases. Because of the logarithm, the noise in these quantities also increases as the response of the molecular-weight-sensitive detector decreases. Thus, the noise in (log (Rᵢ/cᵢ) and log (η_{sp,i}/cᵢ) increases dramatically in the tails (leading and trailing edges) of a chromatographic peak.

### SUMMARY OF THE INVENTION

The inventive method employs a GPC chromatograph system followed by one or more detectors. The detectors contemplated within the scope of the invention are a multi-angle laser light-scattering (MALLS) detector, a refractive index (RI) detector, and a viscometer (V) detector.

The RI, MALLS, and V detectors are used to measure, respectively, the concentration cᵢ, the Rayleigh ratio ΔR_{i,j} and the specific viscosity η_{sp,i}, for each slice i. Hereafter, we refer to a MALLS detector as simply a light scattering detector or LS detector, with the understanding that a LS detector refers to a multi-angle light scattering detector.

An example of such a system is an integrated Alliance GPCV 2000 system by Waters Corporation, Milford, Mass. that incorporates an on-line differential refractometer (RI) and a differential capillary viscometer (V) detector. Included in the system is a dual-angle static light scattering (MALLS) detector PD 2040 by Precision Detectors, Franklin, Mass. A set of three 10 μm Waters Styragel columns (7.8 mm I.D.×300 mm) are an example of columns that can be used for size-exclusion separation other columns known in the art are contemplated within the scope of the invention. There are two HT 6E mixed bed linear columns with effective MW range 5×10³-10⁷ g/mol, and one HT 2 with effective range 10²-10⁴ g/mol.

The present invention provides several data analysis methods that can be applied to the data acquired from a chromatographic system that includes a multi-angle laser light-scattering (LS) detector by itself, or in combination with either or both an RI or V detector. Thus, the detector configurations considered within the scope of the invention are four configurations: LS, LS-RI, LS-V, and LS-RI-V. The inventive methods contemplate one or more novel algorithms specific to each detector configuration.

Central to all inventive algorithms is the computation of the radius of gyration for each slice i. The radius of gyration, r_{g}, of a molecule is its root-mean-squared radius averaged over all conformations. It is well know in the art that the size of the molecule, as measured by its radius of gyration, affects how the intensity of scattered light changes as a function of the scattering angle at which the intensity is measured. Thus measuring the intensity of scattered light at different angles with respect to the incident beam is a method by which the radius of gyration of a molecule can be measured is well described in the text of (Mendichi, R. Radius of Gyration Measurements by GPC-SEC, in Encyclopedia of Chromatography. ed. J Cazes, Marcel Dekker, Inc., New York, 2001, pp 704-706), which is incorporated herein in its entirety by reference.

### BRIEF DESCRIPTION OF THE DRAWINGS

The foregoing and other features and advantages of the present invention will be more fully understood from the following detailed description of illustrative embodiments taken in conjunction with the accompanying drawings in which:

FIG. 1. is an overview of a Gel Permeation Chromatography system which provides data to be analyzed by a system including the present invention;

FIG. 2 is an illustrative computer system for analyzing data according to the present invention;

FIG. 3A shows the form factor of the line model;

FIG. 3B shows the form factor curves sample at seven angles;

FIG. 3C illustrates the effects of noise on measurements of the form factor;

FIG. 4A shows the difference in Rayleigh ratios from different scattering functions as compared to linear model;

FIG. 4B is a graph showing simulation of the MWD of a sample. The X-axis is log MW, the Y-axis is proportional to dW/dlogMW;

FIG. 5 depicts three intrinsic viscosity laws are plotted, which are the linear Mark-Houwink law (1), the Zimm-Stockmayer IV law (2), and a quadratic polynomial law (3) The x-axis is log MW and the y-axis is log[η];

FIG. 6A is a graph showing a molecular weight calibration curve;

FIG. 6B is a graph showing concentration profile. The x-axis is elution volume, and the y-axis is log MW;

FIG. 7 graphically depicts the three detector responses versus elution volume. The three detector responses from the RI, LS, and V detectors are refractive index, Rayleigh ratio and specific viscosity of the sample. The x-axis is elution volume (proportional to slice number). The y-axis is arbitrary; and

FIG. 8 depicts the detector responses with the inclusion of baseline noise.

### DETAILED DESCRIPTION OF THE INVENTION

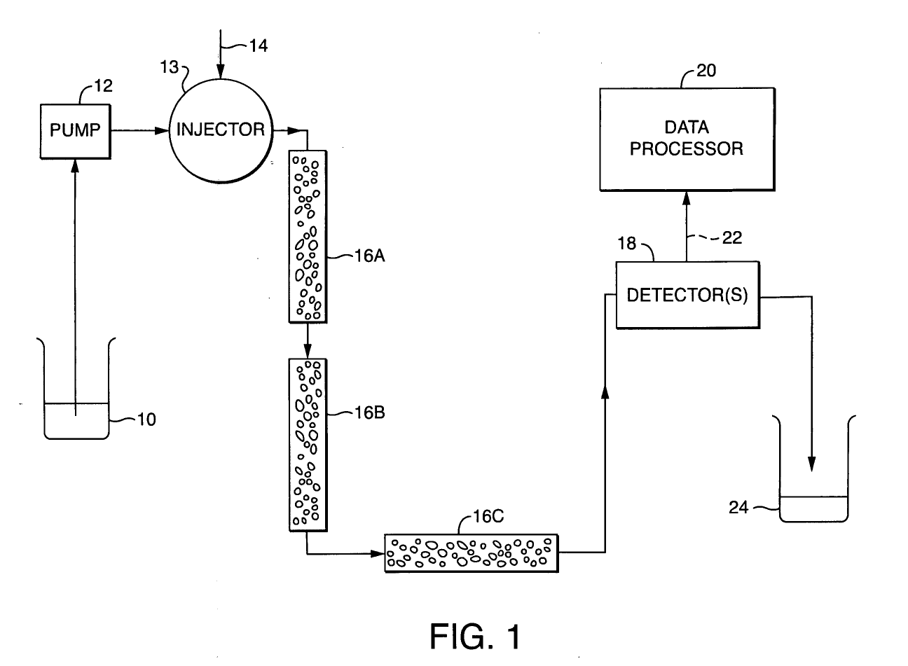

An illustrative gel permeation chromatography (GPC) system for determining radius of gyration, molecular weight and intrinsic viscosity of a polymeric distribution is illustrated in FIG. 1. A solvent reservoir 10 provides solvent that is pumped by a solvent pump 12. At the injection valve 13, the polymeric sample 14 is introduced into the solvent flow. The solvent along with the polymeric sample 14 then passes through a set of columns 16 which contain the chromatographic bed. The solvent then passes through a detector 18, where one or several detectors analyze the solution and determine the presence and properties of polymer chains. This information is supplied to a data processor 20, as shown by arrow 22. The waste solution then collects in a container 24.

The GPC separation is effected by a pump that forces the solvent through the set of columns 16 containing packed beads (the chromatographic bed) that possess a distribution of pore sizes. In one illustrative embodiment of such a separation a chromatograph employing an Alliance 2690 Solvent Delivery System, Waters Corporation, Milford, Mass., and Styragel Columns, Waters Corporation, Milford, Mass., is used. A set of three 10 μm Waters Styragel columns (7.8 mm I.D.×300 mm) are an example of columns that can be used for size-exclusion separation. These are two HT 6E mixed bed linear columns with effective MW range 5×10³-10⁷ g/mol, and one HT 2 with effective range 10²-10⁴ g/mol.

An injector mechanism introduces the polymer sample into the flowing solvent stream. The Alliance 2690 contains such an injection mechanism. Injection of the sample 14 into the flowing stream forces it through the column set 16. The separation is effected by a sieving mechanism. The pores exclude the larger molecules and retain the smaller molecules. Larger molecules see a column set having a relatively small effective volume. Smaller molecules see a column set having a relatively large effective volume. Consequently, larger molecules elute first, and the smaller molecules elute later. The detectors 18 follow the column set 16 and measure the physical properties of the eluent.

The detectors follow the column set and measure the physical properties of the eluent as a function of time after injection of the sample. Typical detectors used in GPC measure refractive index (RI), viscosity (V), or the light-scattering (LS) of the eluent. The typical signal output of detectors is a fluctuating analog voltage. Typically, the analog signal is samples at a regular period, typically once per second. The sampled voltages are converted to digital form by an A/D converter.

A computer is part of the GPC chromatographic system. The computer controls the chromatographic pump, injectors and detectors, as well as recording the digitized data from the detectors. Of relevance to this disclosure, the digitized measurements and the times of the sampling are stored in a computer memory, such as a disk drive. The software that displays and processes the data resides within the computer. Our algorithm resides in the computer. After the separation is complete, the algorithm is used to process the data.

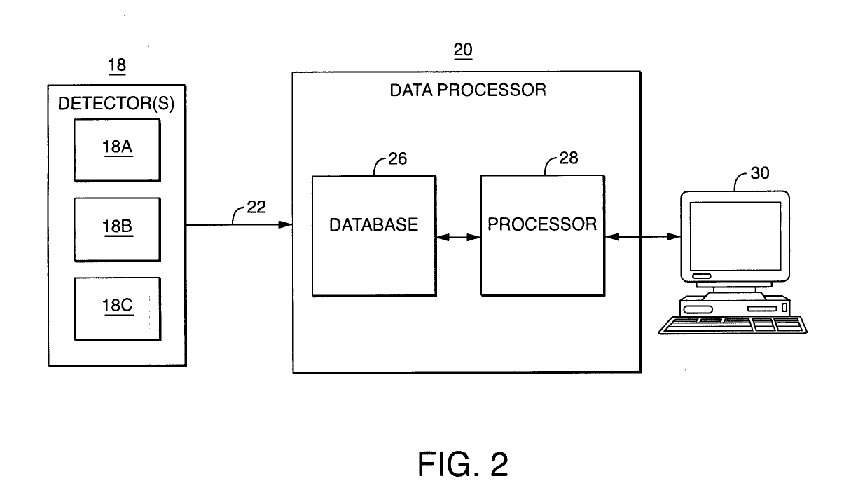

The data processor 20, as depicted in FIG. 2, includes a database 26 and a processor 28. The database 26 includes long-term storage such as magnetic disks, tapes and opto-magnetic discs. It is contemplated within the scope of the invention that other long term storage known in the art may be used. The database 26 in this illustrative embodiment is a relational database. The processor 28 accesses the data stored in the database 26 for processing and producing information that may be stored back in the database 26, or displayed on a workstation 30, or printed out (not shown). The data processor 20 can also include instrumentation to process and convert the data 22, including A/D (analog to digital) conversion circuits, sample and holds, and other devices (not shown).

In the illustrative embodiment, the data processor is a general purpose computer, such as an Intel Pentium® based personal computer running Microsoft Windows® XP or Windows NT. It is contemplated within the scope of the invention that other processors known in the art may be used. The processing application software is Millennium³²® as produced by Waters Corporation of Milford, Mass. Millennium³²® is a chromatography information and systems manager that allows a chromatographer to control instrumentation, and to acquire, store and retrieve data obtained from detectors. It also allows the chromatographer to process that data and store, retrieve display, and print the processed results in graphical and tabular form.

Another component is the application software that processes and extracts information from the data and presents it in reports. A report generator allows the user to create, manage and print reports. A graphical user interface (GUI) allows the user to interact with all these subsystems and components from the monitor. The illustrative embodiments of the present invention is implemented within the data processing component of Millennium³².

The choice of detectors determines what we can learn about a polymeric distribution. In a first illustrative embodiment, the data from the LS detector that determines the radius-of-gyration r_{g}. If only a LS detector is used then all we will learn is the value of r_{g} for each slice r_{g,i}≡r_{g}(Vᵢ). The first inventive method implements a more accurate computation of R_{g,i} from the LS data.

In a second illustrative embodiment, a LS-RI configuration is employed, the method disclosed for this dual-detector configuration allows a more accurate computation of R_{g,i} the conformation law, (CL), R_{g}(M), and the MWD for the polymeric sample. The CL is an important intrinsic property of polymer samples. For many polymers, the conformation law is that of a power law with respect to molecular weight, where r_{g}∝M^{α}. The parameterized form of the conformation law is commonly written as
log r_{g}=k+α log M
where the slope α can identify the macromolecular conformation of the polymers that make up the distribution (e.g, a sphere has α=⅓, a rod has α=1; and a random coil has α= 1/2).

In a third illustrative embodiment, along with the LS-RI data, the column calibration H(Vᵢ) is known, this method is presented to obtain the sample's IV law from this data and the column calibration. The column calibration H(Vᵢ) is the column's hydrodynamic volume versus elution volume. H(Vᵢ) can be obtained from the data obtained from GPC analysis of narrow, mono-dispersed standards.

In a fourth illustrative embodiment of this invention, the triple detector configuration of LS-RI-V, includes a method that determines R_{g}(Vᵢ), CL, MWD, and IV, and H(V). Again, if, along with the LS-RI-V data, the column calibration H(V) is known from independent measurement, then we can compare H(V) measured two ways (once from the triple detection data and once from narrow standards) to obtain a measurement of local polydispersity of the sample.

When included in a system, the RI detector is used to measure a peak's concentration profile. In place of an RI detector, it is contemplated within the scope of the invention that a suitably calibrated UV/V is absorbance detector, evaporative light scattering detector (EVS), or infrared (IR) detector can be used to measure a peak's concentration profile.

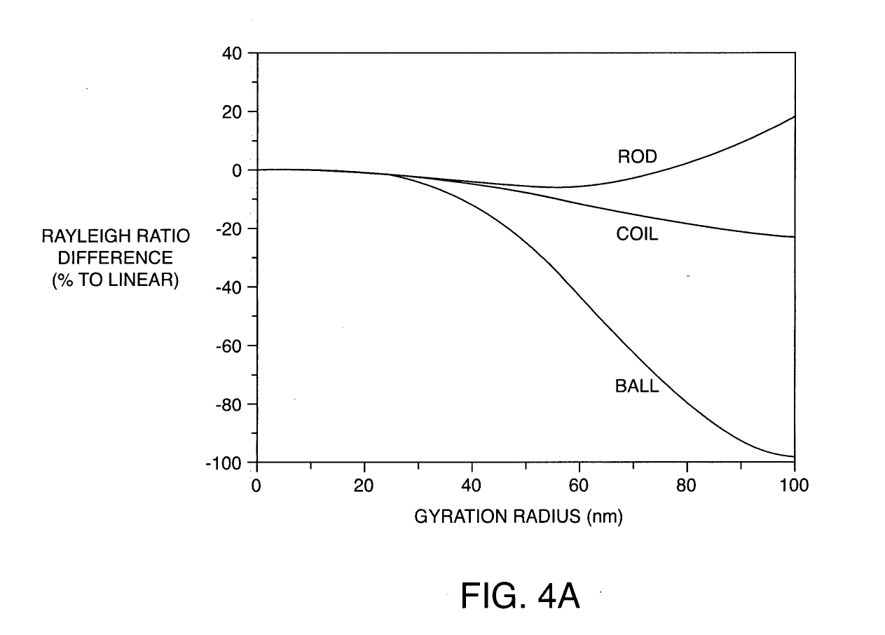

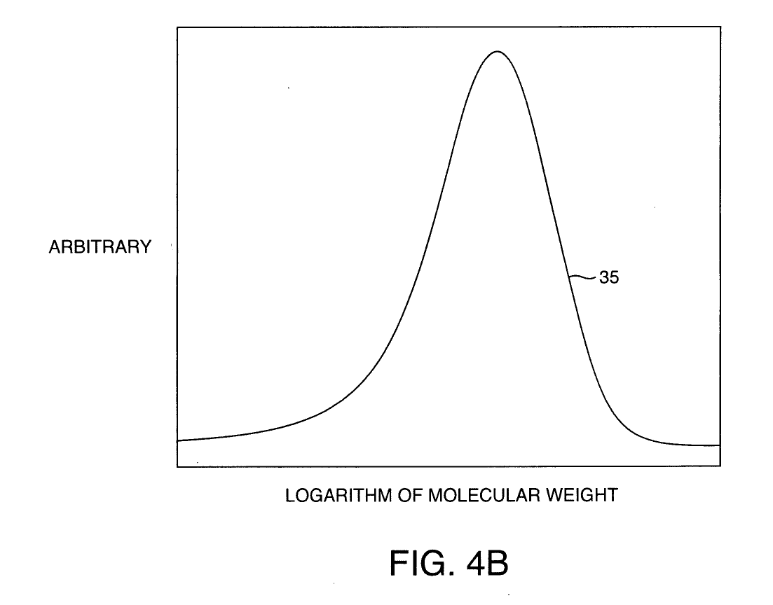

A polymeric sample contains a distribution of chain lengths. The sample's MWD can be described by the relative mass (or concentration) per unit interval of molecular weight. Because of the kinetics governing the synthesis of polymers, these distributions are conventionally described by the relative mass per unit of the logarithm of MW, as shown in FIG. 4B. The horizontal axis is log MW and the vertical axis is proportional to dW/dlogMW.

Each polymeric sample possesses a refractive index increment described by dn/dc, the change in the solution's refractive index per unit change of sample concentration. The product of a molecular weight distribution (dW/dlogM versus log M) times dn/dc, gives the refractive index distribution of that sample in a given solvent system.

Rayleigh light scattering describes the scattering of light by a polymer chain, when the wavelength λ of the incident light is comparable to or larger than the size of the chain. Assume an incident beam of un-polarized light of intensity I₀, low sample concentration c, low scattering angle θ, and small particle size. Assume that the sample in a unit volume of solution scatters the light into direction θ with respect to the beam. That part of the intensity of the light that scattered by the sample I(θ) and received at distance r is given by

$$\frac{I ( θ )}{{I}_{o}} = \frac{{K}^{*} ( 1 + {cos}^{2} θ ) c M}{{r}^{2}} \qquad Eq . ( 10 )$$

where K* is the optical constant expressed in terms of numerical and physical constants, as

$${K}^{*} = \frac{2 π}{{N}_{A}} {( {n}_{o} \frac{ⅆ n}{ⅆ c} )}^{2} \frac{1}{{λ}^{4}} , \qquad Eq . ( 11 )$$

where N_{A} is Avogadro's number, and no is the refractive index of the solvent.
The excess Rayleigh's ratio, defined to be independent of instrumental geometry, is given by

$$R ≡ \frac{I ( θ )}{{I}_{O}} \frac{{r}^{2}}{( 1 + {cos}^{2} θ )} . \qquad Eq . ( 12 )$$

For small angles and low concentration, we have that for slice i
Rᵢ=cᵢMᵢK*, Eq. (13)
so that the excess Rayleigh ratio is simply the product of the slice's concentration, molecular weight, and the optical constant K*.

Rayleigh scattering occurs when the intensity of scattered light is proportional to the product of sample concentration and molecular weight. The scattering will, in general, also depend on the scattering angle. Light scattered near zero angle deflection, (also called low angle light scattering) is almost exactly proportional to the product of concentration times mass and is nearly independent of the size (radius of gyration) of the molecule.

Scattering at large angles (typically angles between 15 degrees and 145 degrees) will generally have reduced scattering intensity as compared to 0 degrees. For angles larger than zero degrees, the ratio of size of the molecule (as measured by its radius of gyration) to the wavelength of the beam determines the rate of reduction of intensity with angle. The larger the size, the more rapid the reduction.

Modern light-scattering detectors, designed for on-line chromatographic separations, illuminate the sample in a flow cell with a polarized laser, and the intensity of the scattered light is measures simultaneously (or nearly simultaneously) at two or more angles. For example a Precision Detector LS detector measures scattering at 15 and 90 degrees. A Wyatt mini-Dawn measures scattering at three angle, 45, 90, and 135 degrees.

The LS detector measures the Rayleigh ratio, ΔR_{i,j} is subscripted by i and j. The index i refers to the slice number and the index j refers to the scattering angle θⱼ. Thus for slice i, ΔR_{i,j}≡ΔR(Vᵢ,θⱼ) gives the Rayleigh ratio at elution volume Vᵢ and angle θⱼ.

The inventive method addresses the subtle interactions that a more complex expression of the excess Rayleigh ratio takes into account. These subtle interactions involve the size of the scattering particle (as particle sizes become comparable to λ), the concentration of the solution (as chain-chain interactions described by the second virial coefficient become important), and the observation of scattering at non-zero angles.

The scattering form factor is introduced to take into account the cancellation (interference) effects of lights scattered from different parts of a molecule when its dimension is close or exceed 1/20 of the wavelength in the solvent. The definition is:

$$P ( θ ) ≡ \frac{Δ {R}_{θ}}{Δ {R}_{θ = 0}}$$

from “Introduction to Polymers” 2^{nd} Edition by R. J. Young and P. A. Lovell, which is incorporated in its entirety by reference.

The scattering function depends on the size and shape of the molecule, as indicated by the three models (sphere, coil and rod) below. The “linear” model represents a straight line in Zimm plot (ΔR_{θ}⁻¹˜sin²(θ/2)). The result χ² of the fit for a given model should indicate the goodness of modeling.

$$\begin{matrix}Linear \text{:} \\ {P}_{line} ( u ) = \frac{1}{1 + u / 3} & Eq . ( 14 ) \\ Sphere \text{:} \\ {P}_{ball} ( u ) = \frac{243}{125} \frac{1}{{u}^{3}} ( sin ( \sqrt{\frac{5 u}{3}} ) - \sqrt{\frac{5 u}{3}} cos ( \sqrt{\frac{5 u}{3}} ) ) & Eq . ( 15 ) \\ Coil \text{:} \\ {P}_{coil} ( u ) = 2 \frac{u - 1 + {e}^{- u}}{{u}^{2}} & Eq . ( 16 ) \\ Rod \text{:} \\ {P}_{rod} ( u ) = \frac{1}{\sqrt{3 u}} {\int }_{0}^{2 \sqrt{3 u}} \frac{sin x}{x} ⅆ x - {( \frac{sin ( \sqrt{3 u} )}{\sqrt{3 u}} )}^{2} & Eq . ( 17 ) \\ Polynomial \text{:} \\ {P}_{m} ( u , a ) = \frac{1}{1 + \frac{u}{3} + a \cdot {u}^{2}} & Eq . ( 18 ) \\ where \\ u = {( \frac{4 π {n}_{s}}{λ} )}^{2} {R}_{g}^{2} sin ( \frac{θ}{2} ) and {R}_{g}^{2} = 〈 {r}_{g}^{2} 〉 & Eq . ( 19 )\end{matrix}$$

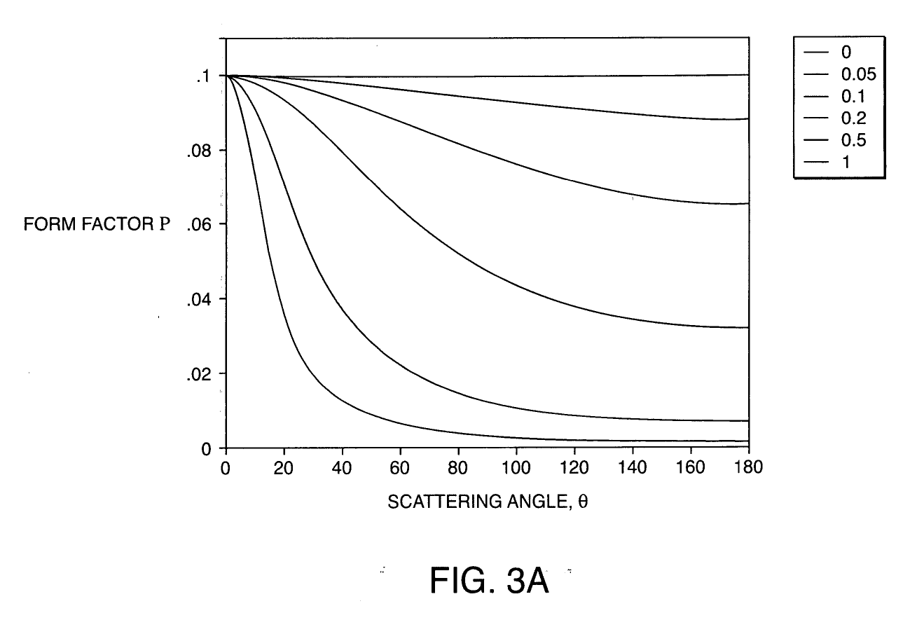

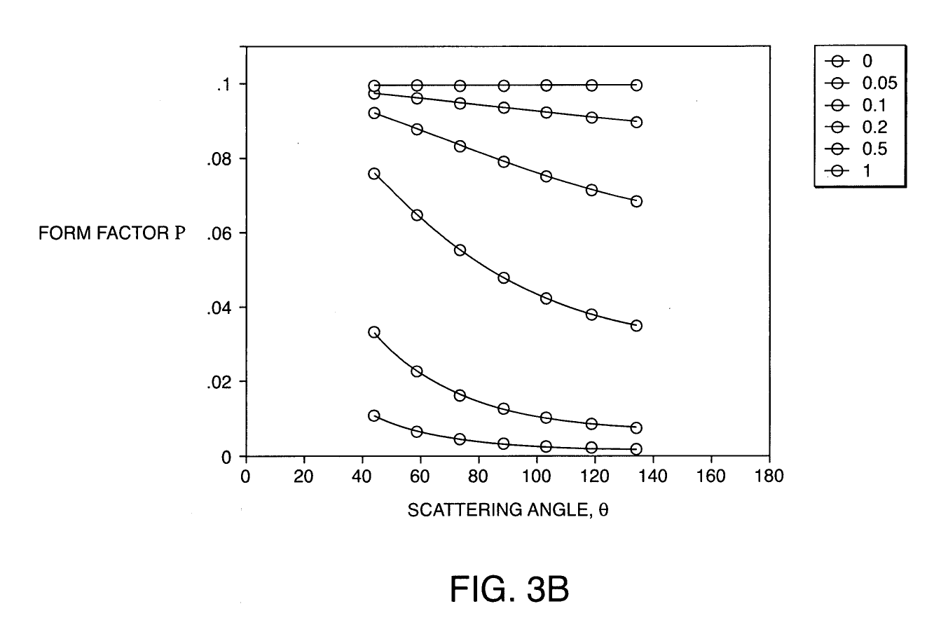

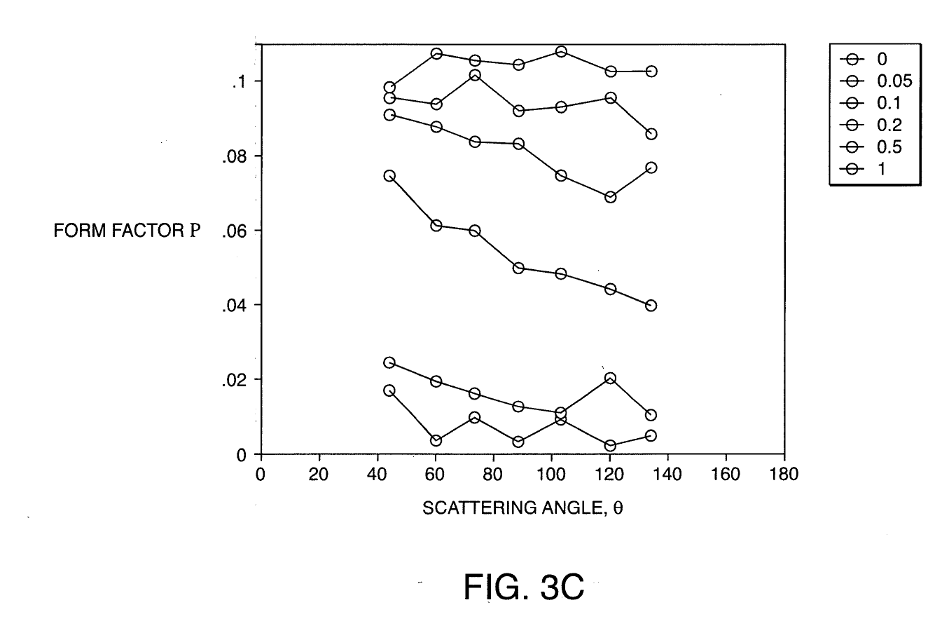

To illustrate these expressions, FIG. 3A shows the form factor of the line model,

$${P}_{line} ( u ) = \frac{1}{1 + u / 3} ,$$

as a function of

$$\frac{{R}_{g}}{{λ}_{n}}$$

and θ (Eq. 14 and 19).

In FIG. 3A, the horizontal axis is the scattering angle θ, and each curve represents the ratio of a molecule's r_{g} to the laser wavelength normalized to the solvent index of refraction λₙ≡λ/n . A molecule whose size is small compared to the λₙ exhibits constant form factor at each angle. As the value for r_{g} increases, the scattered intensity at zero angles is unchanged, but the rate of fall off in scattered intensity becomes larger. It is the measurements of form factor over a range of angles that allow the measurement of r_{g} of the molecule from LS detection.

Instrumental non-idealities increase the difficultly of estimating r_{g}. FIG. 3B shows the same curves, but sampled only at seven angles, 45, 60, 75, 90, 105, 120, and 135 degrees. Obviously LS detectors that collect measurements at fewer angles provide less information with which to obtain accurate estimates of r_{g}.

Further, at lower concentrations, in the tails of a distribution, each of these measurements can be significantly affected by noise. FIG. 3C illustrates the effects of noise on measurements of the form factor.

Finally, the form factor is model dependent. FIG. 4A shows how significantly the different models affect the processing results, depending on the gyration radius (difference in Rayleigh ratios as compared to linear model):

The inventive method makes better use of the data in the tails of the distribution than do methods of the prior art. The inventive method replaces the slice-by-slice computations of critical quantities with parameterized models that are fit simultaneously to all the data collected at each slice. It is this simultaneous use of LS data obtained at all slices and at all scattering angles that improves the estimate of the radius of gyration of the molecule as a function of elution volume or molecular weight.

In particular, the methods of the prior art determine r_{g,i} for each slice as a first step, and then fits a model r_{g}(V; Pₘ)=10^{ΣP}^{ₘ}^{V}^{^{m}} to these slice values in a second step. In the inventive method disclosed here, the model r_{g}(V; Pₘ)=10^{ΣP}^{ₘ}^{V}^{^{m}} is fit simultaneously to all data at each slice, thereby, simultaneously determining r_{g,i} and the fitting parameters.

The inventive method gives better results because it is significantly less sensitive to the effects of detector noise than are the methods of the prior art. The extreme sensitivity to detector noise occurs when the independent fits to each slice are performed; the disclosed method, by bypassing this step, avoids introducing excess noise into the determination of r_{g,i}.

Thus the slice values that are obtained from the results of the fit are more stable then values obtained from independent slice computations as in the prior art. A further advantage of the model-fitting approach is that the model parameters can be properties intrinsic to the polymer distribution, such as branching parameters.

The inventive methods disclosed within all start with a first step that estimates r_{g} for each slice using only the LS data. The inventive methods disclosed within all start with a first step that uses only the LS data. In this step, all the LS data, collected from each angle and from each slice, is used. These data are used to determine a model for r_{g}, and it is from this model that a value of r_{g,i} is obtained for each slice i.

In a first illustrative embodiment the calibration model assume that r_{g} can be modeled as a polynomial of elution volume:

$$log {r}_{g} ( V ; {P}_{m} ) = {\sum }_{m} {P}_{m} {V}^{m} or {r}_{g} ( V ; {P}_{m} ) = {10}^{\sum {P}_{m} {V}^{m}}$$

Pₘ is the array of polynomial coefficients, where this model is fit directly to the light scattering data.

This fit is carried out by rearranging the terms in the χ² fit so that that R_{g}(Vᵢ) is determined only by the ratio of the measured intensities of the light-scattering channels. One possible non-linear fit that is expressed in terms of ratios is as follows:

$${χ}^{2} = {\sum }_{i , j \neq 0} {[ \frac{Δ {R}_{i , j}}{Δ {R}_{i , 0}} - \frac{P ( {u}_{i , j} )}{P ( {u}_{i , 0} )} ]}^{2} \qquad Eq . ( 20 )$$

The subscript 0 refers to the scattered intensity measured at one of the channels, e.g., ΔR_{i,0}=ΔRᵢ(θ₀) (r_{g} can be obtained with out performing the absolute calibration of the LS detector). Only the relative calibrations at each angle need be determined.

Another, advantage of the inventive method is that the Rayleigh ratio at zero angle, ΔRᵢ⁰, is not a fitting parameter in this formulation. This advantage becomes crucial both in the tails of the chromatogram and in the low molecular mass (late eluting) region of the GPC chromatogram. In the method of the prior art, the fitting parameters ΔRᵢ⁰ can become highly correlated with the parameters that describe r_{g}. By eliminating the role of ΔRᵢ⁰, the inventive method produces stables estimates of r_{g} even in the tail and low mass regions.

The above fit could be used, but the preferred method rearranges this fit and optimizes the following χ²:

$${χ}^{2} = {\sum }_{i , j \neq 0} {[ Δ {R}_{i , j} - Δ {R}_{i , 0} \frac{P ( {u}_{i , j} )}{P ( {u}_{i , 0} )} ]}^{2} . \qquad Eq . ( 21 )$$

This formulation is preferred because the noise in each term is symmetric about zero, and produces a less biased fit than would the previous form.

In the above expressions, u_{i,j} is calculated from model r_{g} at i-th slice:
uᵢⱼ=k²r_{g}(Vᵢ)²Xⱼ Eq. (22)
and Vᵢ is the elution volume at i-th slice, and

$${X}_{j} = {sin}^{2} ( \frac{{θ}_{j}}{2} ) \qquad Eq . ( 23 )$$

This formulation of χ², takes advantage of the fact that the model of r_{g} is fit to all the light-scattering data directly. The least-squares fit is carried out over the whole of the peak region.

This model can be generalized to weight each channel separately, as different channels have different noise. The weight function for each channel is determined by the detector noise level in that channel. The least-squares fit can still be carried out over the whole of the peak region taking into account weighting as follows.

$${χ}^{2} = {\sum }_{i , j \neq 0} {[ \frac{Δ {R}_{i , j} - Δ {R}_{i , 0} \frac{P ( {u}_{i , j} )}{P ( {u}_{i , 0} )}}{{σ}_{j}^{2} + {{σ}_{o}^{2} ( \frac{P ( {u}_{i , j} )}{P ( {u}_{i , 0} )} )}^{2}} ]}^{2} . \qquad Eq . ( 24 )$$

The denominator is a model of the noise present in the numerator. The denominator

$${σ}_{j}^{2} + {{σ}_{o}^{2} ( \frac{P ( {u}_{i , j} )}{P ( {u}_{i , 0} )} )}^{2}$$

is the sum of the squares of the standard error of each of the two terms in the numerator, this weighting assumes constant noise σⱼ per channel for all time samples.

In the inventive method, the slices having the highest signal to noise (typically found in the heart-of-the peak) automatically determine the properties of the r_{g}(V) curve. The slices having the lowest signal to noise have little effect on the determination. of the curve. Thus, the inventive method allows all data to be used, including data in the tails of the distribution. Thus it is not necessary to restrict the fit to a region of high signal to noise. This is, unlike methods of the prior art that are typically affected by the noise in the tails of the peak and therefore require the user to manually restrict the fit to a good data region, typically the heart of the peak. Unlike the inventive methods, the methods of the prior art require the choice of a good data region.

Once the model is fit, the Rayleigh ratio at any angle can be obtained from the scattering model fit to the data:

$$Δ {R}_{i} ( θ ) = \frac{P ( {u}_{i} ( θ ) )}{P ( {u}_{i , 0} )} Δ {R}_{i , 0} \qquad Eq . ( 25 )$$

The subscript 0 refers to one of the measured angles chosen to be the reference angle. This expression can also be evaluated for θ=0 to obtain the Rayleigh ratios at zero degrees for each slice. Thus, it is this evaluation where the disclosed method first requires a calibrated LS detector.

Rather than being a fitting parameter (as in the prior art), the Rayleigh ratio at zero angles for all slices is determined according to the invention only by the calibration of the LS detector.

LS calibration is well known in the prior art, and preferably consists of performing a GPC separation of a single chemical component with a known molecular weight. The calibration is obtained for the reference channel.

As a special case for the fit, the zero-order polynomial fit is used in narrow LC-LS peak processing to calculate the r_{g}(V), while the 1^{st} order r_{g}(V) fit is used in narrow GPC/V-LS peak processing.

The determination of a polymer sample's CL by GPC using RI-LS detection is a well-established technique. A detailed description of MWD determination in GPC with these two detection techniques is disclosed in an article entitled “Molecular Weight-Sensitive Detectors for Size Exclusion Chromatography”, Christian Jackson and Howard G. Barth, pages 103-146 (1995), published in Handbook of Size Exclusion Chromatography, Chromatographic Science Series, Volume 69, Chi-san Wu, editor, Marcel Dekker, Inc. New York, N.Y., which is incorporated by reference in its entirety.

The inclusion of an RI (or UV) detector according to the invention allows the use of the inventive methods in dual detection RI-LS. It is well known within the prior art that dual detection RI-LS can yield the polymer's molecular weight distribution (MWD) and column calibration M(V), as well as r_{g,i} and the conformation law r_{g}(M).

In the method of the prior art, the analysis of the calibrated LS data gave r_{g,i} and ΔR₀(Vᵢ). The Rayleigh ratio ΔR₀(Vᵢ) at zero angle combined with concentration data, cᵢ as obtained from the RI detector, gave M (Vᵢ). In the methods of the prior art, these slice determined values are again noisy in the tails. Methods of the prior art would attempt to produce smooth values by fitting polynomials; and again, truncation of the fit to a good data region would be required.

In a method that was disclosed previously Gorenstein, et al. System And Method For Determining Molecular Weight And Intrinsic Viscosity Of A Polymeric Distribution Using Gel Permeation Chromatography, May 16, 2000, U.S. Pat. No. 6,064,945 (Gorensetein et al.) a method was disclosed to estimate the MWD from RI-LS data, the teachings of which are incorporated in their entirety by reference. However in that disclosure, it was assumed that a value for ΔR₀(Vᵢ) was obtained using methods of the prior art. Once ΔR₀(Vᵢ) and cᵢ were obtained, fits to these values using a model of M(Vᵢ) could be obtained.

In the inventive method disclosed here, two parameterized models are used and are applied in sequence. The first is, again, the fit of the model of r_{g}(V) to the LS data alone, exactly as described above. The second inventive step is the fit of a polynomial model to both the RI and LS data. The LS data is not ΔR₀(Vᵢ) (as in Gorenstein et al.), but rather ΔR_{i,j}, the data obtained at each slice and at each scattering angle

In this second step, the polynomial model is of the molecular weight as a function of elution volume (as in Gorenstein et al.):

$$log M ( V ; {Q}_{m} ) = {\sum }_{m} {Q}_{m} {V}^{m} or M ( V ; {Q}_{m} ) = {10}^{\sum {Q}_{m} {V}^{m}} \qquad Eq . ( 26 )$$

where Qₘ is the array of polynomial coefficients.

The slice determine values for r_{g,i} are calculated from the normalized LS data as described above. From these the scattering form factor is obtained for each slice at each angle, P_{i,j}≡P(k²r_{g,i}²Xⱼ).

Given then the data collected from the detectors ΔR_{i,j} and cᵢ, the method fits the model M(V;Qₘ) by optimizing the following fit:

$${χ}^{2} = {\sum }_{i , j} {[ Δ {R}_{i , j} - {K}_{LS} {v}^{2} \cdot {c}_{i} \cdot M ( {V}_{i} ; {Q}_{m} ) \cdot {P}_{i , j} ]}^{2} \qquad Eq . ( 27 )$$

The fit is to the Rayleigh ratio data obtained at all slices and at all angles.

Again, a weight factor can be included to take into account differing noise levels between the LS channels. This fit can be applied to the complete distribution without the need to select a good data region, or otherwise restrict the fit to the heart of the peak.

As a special case for the fit, the zero-order polynomial fit is used in narrow LC-LS peak processing to calculate the M(V), while the 1^{st} order M(V) fit is used in narrow GPC/V-LS peak processing.

The calibration model is based on a model of molecular weight versus elution volume, M(V; Qₘ). This model is fit to the observed values obtained from the RI and LS detectors. The structural model replaces M(V; Qₘ) with a model of r_{g} as a function of molecular weight. r_{g}(M;Pₘ). The preferred relationship between r_{g} and M can be a polynomial function, expressed as

$$log {r}_{g} ( M ; {P}_{m} ) = {\sum }_{m} {{P}_{m} ( log M )}^{m} or \\ {r}_{g} ( M ; {P}_{m} ) = {10}^{\sum {{P}_{m} ( log M )}^{m}} \qquad Eq . ( 28 )$$

or Zimm-Stockmayer equation, appropriate for branched polymers, expressed as:

$$\begin{matrix}log {r}_{g} ( M ; {K}^{′} , {α}^{′} , λ ) = log {K}^{′} + {α}^{′} \cdot log M - \frac{1}{4} log ( \frac{λ M}{{c}_{1}} + \sqrt{1 + \frac{λ M}{{c}_{2}}} ) \\ or & Eq . ( 29 ) \\ {r}_{g} ( M ; {K}^{′} , {α}^{′} , λ ) = {K}^{′} {{M}^{{α}^{′}} ( \frac{λ M}{{c}_{1}} + \sqrt{1 + \frac{λ M}{{c}_{2}}} )}^{- 1 / 4} & Eq . ( 30 )\end{matrix}$$

The structural fit is carried out in two steps. The first step is still the determination of r_{g,i} obtained solely from the LS detector, as described above. Again, this fit provides the values P_{i,j}≡P(k²R_{g,i}²Xⱼ) of the scattering function for each slice and scattering angle.
In the second step, the model r_{g}(M; Qₘ) is calculated by the following fit:

$${χ}^{2} = {\sum }_{i , j} {[ Δ {R}_{i , j} - {K}_{LS } {v}^{2} \cdot {c}_{i} \cdot M ( {r}_{g , i} ; {Q}_{m} ) \cdot {P}_{i , j} ]}^{2} \qquad Eq . ( 31 )$$

Where M (r_{g,i}; Qₘ) is obtained at each slice by a straightforward inversion of the above structural models r_{g}(M; Qₘ).

Advantageously, this inventive method produces a smooth model for conformation law r_{g}(M; K′, α′, λ) or r_{g}(M; Qₘ) that fits directly to all of the data for both detectors.

Unlike prior art methods, an intermediate model M(V) is not needed, and no noise-sensitive slice value are computed. Any desired slice value, such as the column calibration M(Vᵢ) can be computed from the model fits obtained by the method disclosed herein. In Gorenstein et al., these same structural models were fit to RI-LS data, but the fit to the LS data only involved the Rayleigh ratio at zero angles. The inventive method fits these structural modes to LS data obtained at each slice and at each angle.

In the second illustrative embodiment that discloses a method to analyze dual-detection LS-RI data. This method employs a standard GPC universal calibration curve. This universal calibration curves gives the hydrodynamic volume for each slice, Hᵢ.

This calibration curve Hᵢ can be obtained using standard techniques. For example, the calibration curve can be obtained using the injection of narrow (mono-dispersed) polymer standards. If the standards have known molecular weight, then RI-V detection provides the hydrodynamic volume at the retention volumes at which the standards elute. If the molecular weight of the standards is not known, then RI-LS detection can be used to determine each standard's molecular weight.

In calibration model fit, log[η] is modeled as a polynomial of elution volume.

$$log [ η ] ( V ; {T}_{m} ) = {\sum }_{m} {T}_{m} {V}^{m} or [ η ] ( V ; {T}_{m} ) = {10}^{\sum {T}_{m} {V}^{m}} \qquad Eq . ( 32 )$$

As described earlier r_{g} is first modeled as a polynomial of elution volume r_{g}(V) and is calculated first from the LS data. Then the following fit is performed, which determines the model for log[η]:

$${χ}^{2} = {\sum }_{i , j} {[ Δ {R}_{i , j} - {K}_{LS} {v}^{2} \cdot {c}_{i} \cdot \frac{{H}_{i}}{[ η ] ( {V}_{i} ; {T}_{m} )} \cdot {P}_{i , j} ]}^{2} \qquad Eq . ( 33 )$$

Hᵢ is the hydrodynamic volume read at i-th slice read from the external universal calibration curve, [η]ᵢ are the modeled values at the i-th slice, and the P_{i,j} are obtained from the LS data as described above. Again, the concentration and light-scattering data are used to constrain the model.

Molecular weight M is not modeled, but calculated from given external universal calibration curve and model for [η],
Mᵢ≡Hᵢ/[η](Vᵢ; Tₘ) Eq. (34)

In structural model fit, the intrinsic viscosity [η] is modeled as a function of molecular weight M as following:

$$log [ η ( M ; {S}_{m} ) ] = {\sum }_{m} {{S}_{m} ( log M )}^{m} or \\ [ η ( M ; {S}_{m} ) ] = {10}^{\sum {{S}_{m} ( log M )}^{m}} \qquad Eq . ( 35 )$$

In order to incorporate this model into a fit to the data, a numerical inversion is performed. This inversion is based upon the fundamental definition of hydrodynamic volume:
H=[η]M. Eq. (36)

Thus in terms of known and modeled quantities, Hᵢ=[η(Mᵢ; Sₘ)]Mᵢ for slice i, and this formula is inverted, using standard numerical inversion techniques, to obtain the molecular weight as a function of Hᵢ and Sₘ: Mᵢ=M_{η}(Hᵢ; Sₘ), whence M_{η} is a function of H and the fitting parameters Sₘ.

The next step in the analysis is to then model r_{g} as a polynomial of elution volume r_{g}(V) using the LS data so as to obtain r_{g,i} and P_{i,j}, as has been described above. Finally, the following fit is performed, which determines the parameters that specify the model parameters Sₘ.

$${χ}^{2} = {\sum }_{i , j} {[ Δ {R}_{i , j} - {K}_{LS} {v}^{2} \cdot {c}_{i} \cdot {M}_{η} ( {H}_{i} ; {S}_{m} ) \cdot {P}_{i , j} ]}^{2} \qquad Eq . ( 37 )$$

Once the Sₘ are determined, we have Mᵢ=M_{η}(Hᵢ; Sₘ) and [ηᵢ]=Hᵢ/Mᵢ for each slice.

Just as there are several possible approaches to modeling dual detection data, there are a number of ways of modeling triple detection data. What is common to all inventive models is that the first step is the determination of r_{g,i} and P_{i,j} from the LS data. There are then two approaches to include the RI and V data.

In a first approach, we simply start with the results obtained from the dual-detector RI-LS analysis described above. The RI-V data is processed according to the method described in Gorenstein et al., to obtain the IVL. As described by Gorenstein et al., a model of the sample's intrinsic viscosity is determined using either a calibration or structural fit. The last step in this inventive method is to combine the intrinsic viscosity model and the MWD determination to obtain Hᵢ, the universal calibration curve.

In an alternative approach, we use the RI, V, and LS data to determine values for Hᵢ for each slice. This is accomplished from the polymer under investigation, without the need for the prior determination of the universal calibration of the system. We can then determine either a calibration or structural fits using a variety of models fit to various combinations of detector responses.

Table 1 summarizes the first approach. The first row shows that first step involves only the LS detector and obtains r_{g}(V)

The second row shows that with the inclusions of RI (or UV) data that gives cᵢ, we can perform a calibration fit or structural fit that gives the MWD and the CL.

The third row describes the possible ways of combining the RI/UV and V data to obtain information related to the intrinsic viscosity of the sample. A calibration model or structural model (IVL) can be used.

The fourth row shows that we can combine the intrinsic viscosity data and MWD to obtain the column calibration, or hydrodynamic law H(Vᵢ).

TABLE 1

| LS | Calculate r_{g} | | |
|---|---|---|---|
| | Calibration Fit rgᵢ = r_{g}(Vᵢ) | | |
| | r_{g}(V) = 10^{ΣP}^{ₘ}^{V}^{^{m}} | | |
| LS-RI/UV | Calculate M | Calculate M | |
| | Calibration Fit | Structural Fit | |
| | Mᵢ = M(Vᵢ) | Solve Mᵢ from Rgᵢ = r_{g}(Mᵢ) | |
| | M (V) = 10 ^{ΣQ}^{ₘ}^{V}^{^{m}} | Polynomial Model Rg(M) = 10^{ΣP}^{ₘ} ^{(log M)}^{^{m}} | $\begin{matrix}\text{Zimm-Stockmayer Model} \\ Rg ( M ) = {K}^{′} {{M}^{α′} ( \frac{λM}{{c}_{1}} + \sqrt{1 + \frac{λM}{{c}_{2}}} )}^{- 1 / 4}\end{matrix}$ |
| | $\begin{matrix}\begin{matrix}Calculate {K}^{′} , {α}^{′} and {g}_{i} \\ with given linear region\end{matrix} \\ {r}_{{g}_{i}} = {K}^{′} {M}_{i}^{{α}^{′}} \sqrt{{g}_{i}}\end{matrix}$ | $\begin{matrix}\begin{matrix}Calculate {K}^{′} , {α}^{′} and {g}_{i} \\ with given linear region\end{matrix} \\ {r}_{g , i} = {K}^{′} {M}_{i}^{{α}^{′}} \sqrt{{g}_{i}}\end{matrix}$ | $\begin{matrix}\text{Calculate} {g}_{i} \\ {g}_{i} = {( \frac{{λM}_{i}}{{c}_{1}} + \sqrt{1 + \frac{{λM}_{i}}{{c}_{2}}} )}^{- 1 / 2}\end{matrix}$ |
| VI-RI/UV | Calculate [η] | Calculate [η] | |
| | Calibration Fit | Structural Fit | |
| | [η]ᵢ = [η](Vᵢ) | [η]ᵢ = [η](Vᵢ) | |
| | [η](V) = 10^{ΣS}^{ₘ}^{V}^{^{m}} | Polynomial Model | Hydrodynamic Model |
| | | [η](M) = 10^{ΣS}^{ₘ} ^{(log M)}^{^{m}} | [η](M) = KM^{α}g^{ε} |
| | Calculate K, α and g′i | Calculate K, α and g′i | Note: gᵢ is whatever calculated |
| | with given linear region | with given linear region | from dual-detection above |
| | [η]ᵢ = KMᵢ^{α}g′ᵢ | [η]ᵢ = KMᵢ^{α}g′ | |
| | $\begin{matrix}Calculate {ɛ}_{i} \\ {ɛ}_{i} = \frac{log ( {{g}^{′}}_{i} )}{log ( {g}_{i} )}\end{matrix}$ | $\begin{matrix}Calculate {ɛ}_{i} \\ {ɛ}_{i} = \frac{log ( {{g}^{′}}_{i} )}{log ( {g}_{i} )}\end{matrix}$ | εᵢ ≡ ε |

Calculate H
Hᵢ = Mᵢ [η]_{I}

In the second approach, where we use the RI, V, and LS data to determine for each, the slice hydrodynamic volume (H(V) is modeled as a polynomial of elution volume:

$$log H ( V ) = {\sum }_{m} {S}_{m} {V}^{m} or H ( V ) = {10}^{\sum {S}_{m} {V}^{m}} \qquad Eq . ( 38 )$$

where Sₘ is the array of polynomial coefficients to be determined by a fitting procedure. This model for H is calculated first from using data from all three detectors. The fit is performed by minimizing the following

$${χ}^{2} = {\sum }_{i , j} {[ Δ {R}_{i , j} {η}_{sp , i} - {K}_{LS} {v}^{2} \cdot {c}_{i}^{2} \cdot H ( {V}_{i} ) \cdot {P}_{i , j} ]}^{2} \qquad Eq . ( 39 )$$

Again, the values for P_{i,j} were obtained from the initial analysis applied to the LS data only.

This above fit is based upon the fundamental relationship between the responses of an LS, RI, and V detector to a molecule having a hydrodynamic volume H.

$$H = \frac{Δ {R}^{0}}{{K}_{LS} {v}^{2}} \frac{{η}_{sp}}{{c}^{2}} \qquad Eq . ( 40 )$$

as first described by Brun (Brun, Y. The Mechanism of Copolymer Retention in Interactive Polymer Chromatography, II. Gradient Separation. J. Liquid Chromatography & Rel. Technology, 22 (20) 3067-3090, 1999,) (Brun), which is incorporated by reference in its entirety. This expression does not involve the molecules molecular weight M and allows for the determination of Hᵢ from the sample itself, without requiring the use of external calibration standards.
In this second approach, there are four ways that we can complete the analysis.
I. Calibration Model

In the calibration model fit, the log[η] is modeled as a polynomial of elution volume.

$$log [ η ] ( V ) = {\sum }_{m} {T}_{m} {V}^{m} or [ η ] ( V ) = {10}^{\sum {T}_{m} {V}^{m}} \qquad Eq . ( 41 )$$

Tₘ is the array of the log[η] polynomial coefficients. The non-linear fit optimizes the following χ², using data from two detectors LS and RI, and the previously determined values of Hᵢ and Pᵢⱼ

$${χ}^{2} = {\sum }_{i , j} {[ Δ {R}_{i , j} - {K}_{LS} {v}^{2} \cdot {c}_{i} \cdot \frac{{H}_{i}}{[ η ( {V}_{i} ; {T}_{m} ) ]} \cdot {P}_{i , j} ]}^{2} \qquad Eq . ( 42 )$$

Another possibility is to optimizes the following χ², using data from two detectors LS and V, and the previously determined values of Hᵢ and P_{i,j}

$${χ}^{2} = {\sum }_{i , j} {[ Δ {R}_{i , j} - {K}_{LS} {v}^{2} {η}_{sp , i} \frac{{H}_{i}}{{[ η ( {V}_{i} ; {T}_{m} ) ]}^{2}} {P}_{i , j} ]}^{2} \qquad Eq . ( 43 )$$

This formulation may be advantageous for polymers that have little RI response due to a preponderance of molecules having high molecular weight.
II. Structural Model
In the structural model fit, both intrinsic viscosity [η] and r_{g} are modeled as function of molecular weight M as following:

$$\begin{matrix}log [ η ] ( M ) = {\sum }_{m} {{S}_{m} ( log M )}^{m} or [ η ] ( M ) = {10}^{\sum {{S}_{m} ( log M )}^{m}} & Eq . ( 44 ) \\ log {r}_{g} ( M ; {P}_{m} ) = {\sum }_{m} {{P}_{m} ( log M )}^{m} or {r}_{g} ( M ; {P}_{m} ) = {10}^{\sum {{P}_{m} ( log M )}^{m}} & Eq . ( 45 )\end{matrix}$$

or Zimm-Stockmayer equation, where λ and ε are also the fitting parameters:

$$\begin{matrix}log [ η ] ( M ) = log K + α \cdot log M - \frac{ɛ}{2} log ( \frac{λ M}{{c}_{1}} + \sqrt{1 + \frac{λ M}{{c}_{2}}} ) & Eq . ( 46 ) \\ log {r}_{g} ( M ) = log {K}^{′} + {α}^{′} \cdot log M - \frac{1}{4} log ( \frac{λ M}{{c}_{1}} + \sqrt{1 + \frac{λ M}{{c}_{2}}} ) & Eq . ( 47 ) \\ [ η ( M ; K , α , λ ) ] = K {{M}^{α} ( \frac{λ M}{{c}_{1}} + \sqrt{1 + \frac{λ M}{{c}_{2}}} )}^{- ɛ / 2} & Eq . ( 48 ) \\ {r}_{g} ( M ; {K}^{′} , {α}^{′} , λ ) ] = {K }^{′} {{M}^{{α}^{′}} ( \frac{λ M}{{c}_{1}} + \sqrt{1 + \frac{λ M}{{c}_{2}}} )}^{- 1 / 4} & Eq . ( 49 )\end{matrix}$$

Again, Hᵢ=[η(Mᵢ; Sₘ)] Mᵢ for slice i, and this formula is inverted, using standard numerical inversion techniques, to obtain the molecular weight as a function of Hᵢ and Sₘ: Mᵢ=M_{η}(Hᵢ; Sₘ), whence M_{η} is a function of H and the fitting parameters Sₘ.
The fit that uses LS and RI data is the following:

$${χ}^{2} = {\sum }_{i , j} {[ Δ {R}_{i , j} - {K}_{LS} {v}^{2} \cdot {c}_{i} \cdot {M}_{η} ( {H}_{i} ; {S}_{m} ) \cdot {P}_{i , j} ]}^{2} \qquad Eq . ( 50 )$$

The fit that uses LS and V data is the following:

$${χ}^{2} = {\sum }_{i , j} {[ Δ {R}_{i , j} - {K}_{LS} {v}^{2} \cdot {η}_{sp , i} \cdot \frac{{M}_{η}^{2} ( {H}_{i} ; {S}_{m} )}{{H}_{i}} \cdot {P}_{i , j} ]}^{2} \qquad Eq . ( 51 )$$

Again, for these fits, the Hᵢ was determined using data from all three detectors, as described above, and P_{i,j} again was initially determined from the LS data.

To illustrate these ideas, we assume a special case for the fit, which is the 1^{st} order polynomial calibration fit is used in narrow GPCV-LS peak processing.

The light scattering signal, the Rayleigh ratio, is most commonly expressed in the following way in terms of concentration c, molecular weight M:

$$\frac{K c}{R ( θ )} = \frac{1}{M P ( θ )} + 2 {A}_{2} c \qquad Eq . ( 52 )$$

However, the following equation is used in some references, such as Equation 3.134 of “Introduction to Polymers” 2^{nd} Edition by R. J. Young and P. A. Lovell, P. 186:

$$\frac{K c}{R ( θ )} = \frac{1}{P ( θ )} ( \frac{1}{M} + 2 {A}_{2} c ) where K = {{K}_{LS} ( \frac{ⅆ n}{ⅆ c} )}^{2} and \\ {K}_{LS} = \frac{4 {π}^{2} {n}_{s}^{2}}{{N}_{A} {λ}^{4}} . \qquad Eq . ( 53 )$$

A₂ is the second viral constant. The above formulas apply to the condition that 2 A₂c<<M. In processing, the constant is default to 0, and the units is ml.mol/g².

To incorporate non-zero A₂ constant in the calculation, we take the following unique approach:
For the 1^{st} formula, change it to:

$$K c M P ( θ ) = \frac{R ( θ )}{1 - \frac{2 {A}_{2}}{K} R ( θ )} \qquad Eq . ( 54 )$$

Then a “modified” Rayleigh ratio is introduced:

$${R}^{′} ( θ ) = \frac{R ( θ )}{1 - \frac{2 {A}_{2}}{K} R ( θ )} \qquad Eq . ( 55 )$$

For the “modified” Rayleigh ratio, the equation is as simple as for zero A₂:
R′(θ)=KcMP(θ) Eq. (56)

Therefore, the calculation is greatly simplified since A₂ does not participate in the intermediate steps. The original Rayleigh ratio is converted to the “modified” one, and converted back when the calculation is done.
For the 2^{nd} formula, change it to:

$$R ( θ ) = K c \frac{M}{1 + 2 {A}_{2} c M} P ( θ ) \qquad Eq . ( 57 )$$

Under the assumption that 2 A₂c<<M, we introduce a “modified” molecular weight that is:

$${M}^{′} ≡ \frac{M}{1 + 2 {A}_{2} c M} \qquad Eq . ( 58 )$$

For the “modified” molecular weight, the equation is as simple as for zero A₂. Therefore, calculation is performed with zero A₂. After the calculation is done, the result M′ is corrected to converted it back to M.

At constant flow rate, the pressure drop across a capillary tube P is proportional to the viscosity of the liquid flowing through the tube. If P₀ is the pressure drop due to the solvent alone, then the specific viscosity ηₛₚ of a slice containing a polymer in solution is defined as

$${η}_{sp} ≡ \frac{P - {P}_{0}}{{P}_{0}} , \qquad Eq . ( 59 )$$

where P is the pressure drop due to the polymer-plus-solvent solution. This expression shows that ηₛₚ measures the increase in viscosity caused by the addition of the polymer to the solvent. Each slice has an intrinsic viscosity [η]. The intrinsic viscosity (IV) is defined as ratio of the slice's specific viscosity ηₛₚ divided by its concentration, c, in the limit of low concentration.

$$[ η ] = {lim}_{c -> 0} \frac{{η}_{sp}}{c} . \qquad Eq . ( 60 )$$

In GPC separations, the concentrations are low enough that the intrinsic viscosity for a slice is taken to be the slice ratio as follows:

$${[ η ]}_{i} ≡ \frac{{η}_{sp , i}}{{c}_{i}} . \qquad Eq . ( 61 )$$

The intrinsic viscosity of a polymer varies with its molecular weight. The intrinsic viscosity law describes the dependence of logarithm of the sample's intrinsic viscosity on the logarithm of its molecular weight.

For un-branched polymers, the log[η] is in general is proportional to the logarithm of the chain's molecular weight, logMᵢ. The empirical Mark-Houwink intrinsic viscosity law expresses this linear relationship as
log[η]ᵢ=logK+α logMᵢ Eq. (62)
which is parameterized by the Mark-Houwink constants, K and α.

Polymers can be branched. Zimm and Stockmeyer developed a physical model of long-chain branched polymers, described in Zimm, B. and Stockmayer, W., 1949, J. Chem. Phys. 17, 1301-1314, which is incorporated by reference in its entirety. Based on this work, a model is developed describing the intrinsic viscosity for polymers with long-chain branching, which is called the Zimm-Stockmeyer (ZS) law.

In the ZS law, the distribution's intrinsic viscosity is described by four parameters, K, α, ε and λ.

K and α

The ZS law assumes that at low molecular weight region the polymer is essentially un-branched. In this region, the intrinsic viscosity law is asymptotically linear. The asymptotic slope of the intrinsic viscosity law at low molecular weight is described by the Mark-Houwink constants, K and α.

ε

At high molecular weight, when branching dominates, the asymptotic slope of the intrinsic viscosity law less than α, and is given by (α−ε/2), where ε is the shape factor of the polymer. Values for ε are determined by the polymer/solvent system. For example, ε is approximately 0.9 for a branched polyethylene in TCB. Values for ε range from 0.5 to 1.5.

λ

The molecular weight at which a polymer branches is a stochastic process described by a branching probability. The value λ is defined as the branching probability per Dalton. A typical values for λ is 0.00001 per Dalton.

The ZS Law

The ZS intrinsic viscosity for each slice i is a function of the molecular weight of that slice, Mᵢ and depends on the parameters K, α, λ and ε, as follows:

$${log [ η ]}_{i} = log K + α log {M}_{i} - \frac{ɛ}{2} log [ \frac{λ {M}_{i}}{c} + \sqrt{1 + \frac{λ {M}_{i}}{c}} ] \qquad Eq . ( 63 )$$

The law can be regarded as a generalization of the Mark-Howink law and can describe two possible types of branched polymers, a three-branch point and a four-branch point.

The coefficients for the three-branch point are c₁=9π/4, and c₂₌₇. The coefficients for the four-branch point are c₁=3π/4, and c₂=6.

A third intrinsic viscosity law is simply an empirical description of a sample's intrinsic viscosity based on a polynomial expansion. This “law” is also formulated as an extension of the Mark-Houwink law, so that
log[η]ᵢ=log K+α₁log Mᵢ+α₂ log² Mᵢ+Λ+α_{N} log^{N} Mᵢ Eq. (64)
where N is the order of polynomial, and K and α₁ are the Mark-Howink constants.

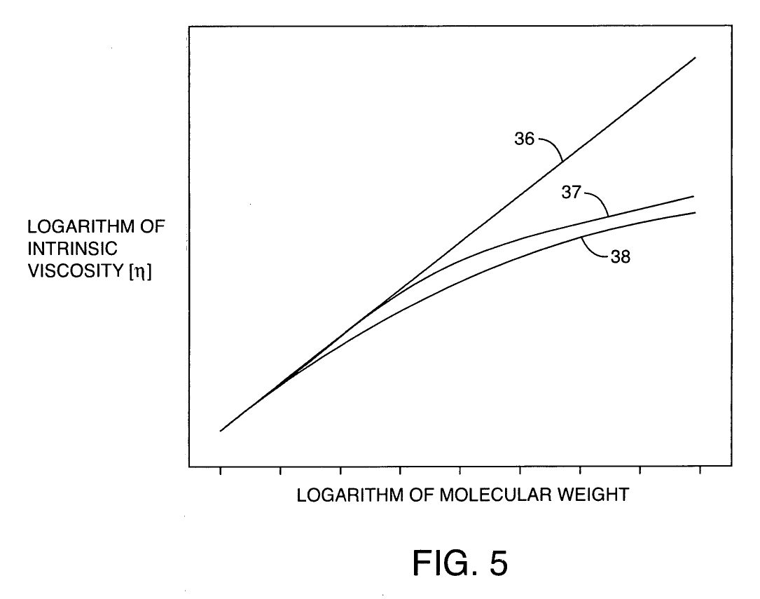

FIG. 5 shows all three intrinsic viscosity laws supper imposed, the linear Mark-Houwink law (36), the Zimm-Stockmayer IV law (37), and a quadratic polynomial law (38).

We have seen that the Rayleigh ratio can have an angular dependence as given by:

$$R ( θ ) = K c \frac{M}{1 + 2 {A}_{2} c M} P ( θ ) \qquad Eq . ( 65 )$$

which we write as ΔR_{θ}=ΔR_{θ=0}×P(θ) to focus on the angular dependence of ΔR_{i,j}.

$$Δ {R}_{i , j} = Δ {R}_{i , 0} \cdot P ( {k}^{2} R {g}_{i}^{2} {sin}^{2} \frac{{θ}_{j}}{2} ) where k = \frac{4 π {n}_{s}}{λ} . \qquad Eq . ( 66 )$$

This formula is general and shows that the light scattering signal responds to a combination of r_{g} and theta.

For a GPC separation, larger molecules elute before small molecules. Thus, the molecular weight of an eluent decreases monotonically with respect to increasing slice number or elution volume. The plot of log MW versus elution volume represents the molecular weight calibration for the sample.

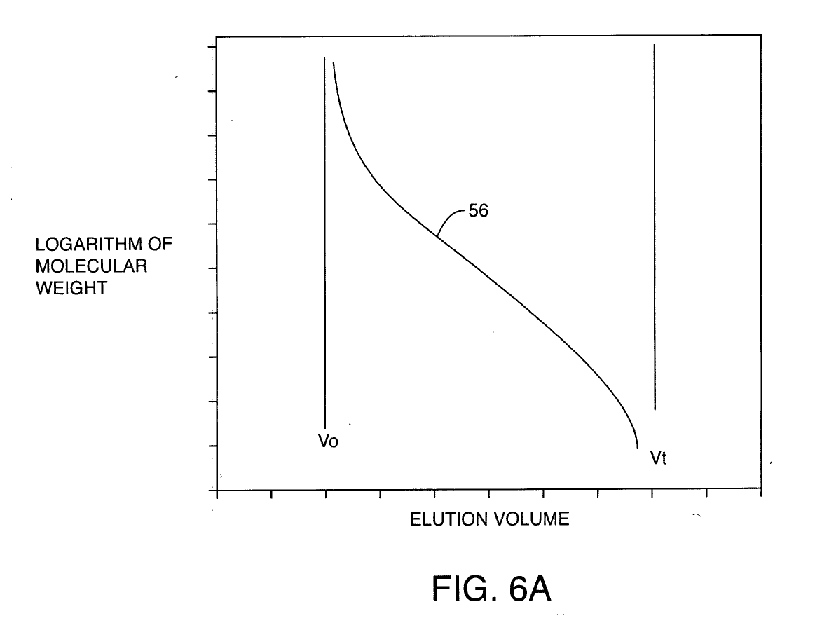

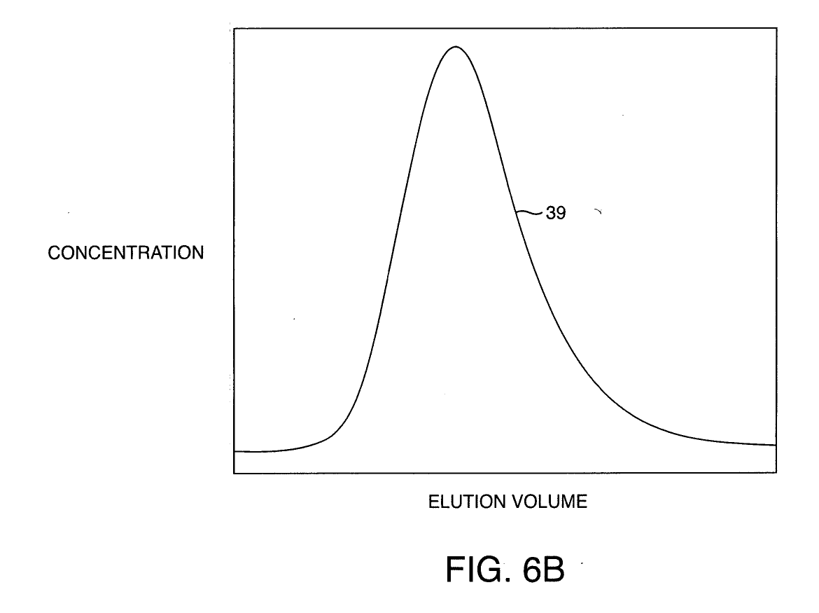

Ideally, this curve would universal, in the sense it would apply to all samples. Unfortunately, this curve is sample dependent (as well as dependent on the solvent and column set, of course). FIG. 6A plots the log of the MW versus elution volume for the sample described in FIG. 4B. FIG. 6B plots the concentration profile of the sample, cᵢ, versus slice i or elution volume. This concentration profile that results from the samples molecular weight distribution as shown in FIG. 4B is determined by this molecular weight calibration curve and the sample's refractive index increment dn/dc.

There is no a priori means to determine the MW calibration curve from a given column, solvent, and sample combination. In practice, the MW calibration curve must be determined by a calibration procedure employing the collected data.

In a GPC separation, the separation is effected by a size-dependent, not mass-dependent, interaction between the polymer chain and the chromatographic bed. The assumption of Universal Calibration introduced by Benoit (Z. Grubistic, R. Rempp, and H. Benoit, J. Polym. Sci., Part B, 5, 753 (1967)) is that the elution volume of a chain depends only on that chain's hydrodynamic volume. The hydrodynamic volume is defined to be the product of the molecular weight of a species times its intrinsic viscosity, as follows:
H≡M[η] Eq. (67)

The physical significance of this definition is understood by substituting the definition of intrinsic viscosity to obtain:

$$H ≡ M [ η ] = M \frac{{η}_{sp}}{c} = \frac{{η}_{sp}}{ρ} \qquad Eq . ( 68 )$$

where ρ is the number density of the molecular species. Thus, hydrodynamic volume measures the viscosity per chain, in contrast to intrinsic viscosity, which measures viscosity per concentration.

According to the inventive method, use narrow standards of any suitable material can be used to construct a hydrodynamic volume calibration curve. Given narrow standards of known molecular weight, RI-V detection determines the hydrodynamic volume for each standard. The standard's hydrodynamic volumes is plotted versus elution volumes, and polynomial curve is fitted to these data to determine the hydrodynamic volume calibration curve. This curve gives the hydrodynamic volume of the column for the elution volume spanned by the narrow standards.

This curve is referred to as either as the universal calibration of the column set, or as the hydrodynamic volume calibration curve. For such a curve to be useful, it must span an elution volume that encompasses the sample's mass distribution.

A properly calibrated RI detector responds to the solution's refractive index at each slice. Given the output of this detector, subtracting the detector's baseline response and dividing by dn/dc for the sample gives the concentration profile of the sample, cᵢ for the ith slice. The concentration profile c, can also be obtained by knowing the mass of material injected into the chromatograph with the assumption that the RI detector responds linearly to sample concentration.

The LS detector responds to the sample by scattering light. Subtracting the detector's baseline response and applying a detector calibration procedure gives the excess Rayleigh ratio due to the sample, Rᵢ, for each slice.

The viscometer detector responds to the solution viscosity. Subtracting the detector's baseline response, and dividing by the viscosity of the baseline gives the specific viscosity of the sample, η_{sp,i}, for each slice.

An additional characteristic of a polymer sample is its intrinsic viscosity law (IVL). The viscometer measure's a sample's specific viscosity, which is the fractional increase in the viscosity of a solution due the presence of a sample. The sample's intrinsic viscosity is the ratio of the sample's specific viscosity to its concentration. The IVL of a sample is its intrinsic viscosity as a function of its molecular weight. RI-V detection of the sample, together with molecular weight calibration provided by the narrow standards provides a means to measure the sample's IVL.

The specific viscosity ηₛₚ is the fractional increase in viscosity due to the presence of a sample. In a viscometer, at constant flow rate, the pressure drop across a capillary tube P is proportional to the viscosity of the liquid flowing through the tube. If P₀ is the pressure drop due to the solvent alone, then the specific viscosity ηₛₚ of a slice containing a polymer in solution is defined as

$${η}_{sp} ≡ \frac{P - {P}_{0}}{{P}_{0}} \qquad Eq . ( 69 )$$

where P is the pressure drop due to the polymer-plus-solvent solution. This expression shows that ηₛₚ measures the increase in viscosity caused by the addition of the polymer to the solvent.

Each slice has an intrinsic viscosity [η]. The intrinsic viscosity (IV) is defined as ratio of the slice's specific viscosity ηₛₚ divided by its concentration, c, in the limit of low concentration.

$$[ η ] = {lim}_{c -> 0} \frac{{η}_{sp}}{c} . \qquad Eq . ( 70 )$$

In GPC separations, the concentrations are low enough that the intrinsic viscosity for a slice is taken to be the slice ratio as follows:

$${[ η ]}_{i} ≡ \frac{{η}_{sp , i}}{{c}_{i}} . \qquad Eq . ( 71 )$$

Thus, it is assumed that for each slice, the baseline-correct and calibrated detector responses give three signal profiles for each slice measurement of the sample: the concentration cᵢ, Rayleigh ratio Rᵢ, and specific viscosity η_{sp,i} for slice i.

Each of these detectors contains non-idealities in their responses. Typically, these non-idealities fall into two categories, baseline drift and stochastic baseline noise.

Baseline drift in a thermally stabilized chromatograph is accurately compensated for by baseline correction procedures.

Baseline noise is an irreducible component of the measurement process. Each of these detectors contains baseline noise at some level. The origin of this noise, seen as fluctuations in the baseline, is the result of several fundamental phenomena. One is the shot noise of the light sources in the RI and LS detectors. The other are the thermal noises associated with amplifiers in all detectors, and the third are fluctuations in the pump flow rate and thermal variations. Particulates, contaminants, and bubbles can also add additional noise components to the signal.

The net result of these effects is manifested as an addition of stochastic noise to the output of each detector. The noises can be described as Gaussian deviates having zero mean and a well-defined standard deviation. The standard deviation of baseline noise will in general be different for the different detectors, but each detector's noise is constant throughout the separation.

Starting with assumed properties of the sample, the column set, and the detectors, a simulation the three profiles of the sample that such a system will produce is developed. The assumed properties of the sample are its MWD and IV law. The assumed properties of the column are its Universal calibration and molecular weight calibration. The assumed properties of the detector are its physical responses and the presence of noise in each detector.

FIG. 4B shows the simulated MWD that is used. The column calibration in FIG. 6A applied to the MWD gives the concentration versus elution volume as it elutes from the column set 39, or c(V) also plotted in FIG. 6B.

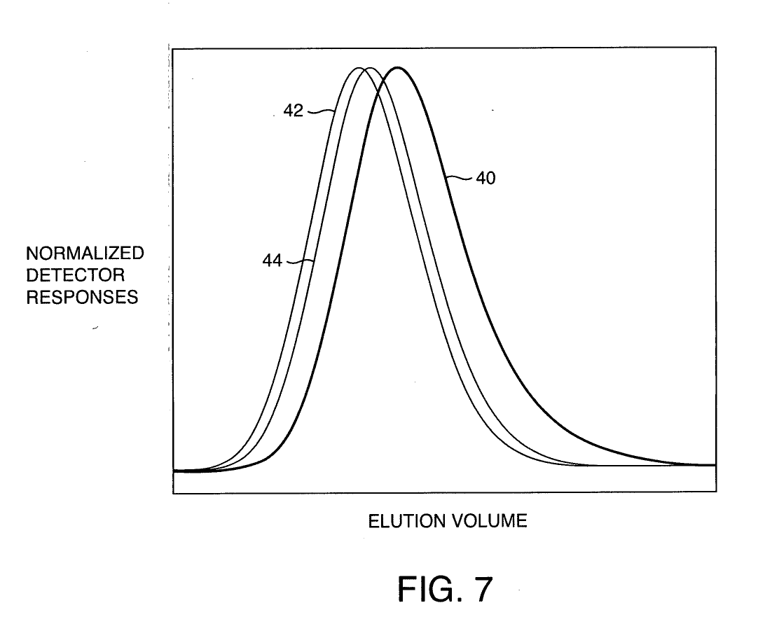

Multiplying the concentration profile by the refractive index increment, dn/dc, gives refractive index versus elution volume 40 in FIG. 7, simulating the RI detector. The calibration of the RI detector gives back the concentration profile cᵢ, that is used in the subsequent analysis.

The excess Rayleigh ratio describes the fraction of incident light scattered by a compound. The excess Rayleigh ratio is proportional to the product of the concentration c, and molecular weight M, and is given by
R=cMK*

The excess Rayleigh ratio versus elution volume 42 is also shown in FIG. 7. The light-scattering profile, which is the excess Rayleigh ratio for each slice Rᵢ, is obtained by multiplying each slice in the concentration profile in FIG. 6B by MᵢK*.

The specific viscosity ηₛₚ is the fractional increase in viscosity due to the presence of the sample. The specific viscosity is simulated by multiplying, slice-by-slice, the concentration times the intrinsic viscosity [η]ᵢ for that slice. The slice's intrinsic viscosity is obtained from the Zimm-Stockmayer intrinsic viscosity law 37, plotted in FIG. 5.

The SV versus elution volume obtained from the viscometer detector is shown in FIG. 7 as curve 44.

Normally, the hydrodynamic calibration curve is obtained from narrow molecular weight standards. For the purpose of simulation, simulated column sets universal calibration are obtained for each slice by multiplying each slice's the sample's molecular weight times its intrinsic viscosity. The inputs to this calculation are the column's molecular weight calibration curve FIG. 6A and the sample's intrinsic viscosity law (FIG. 5, curve 37).

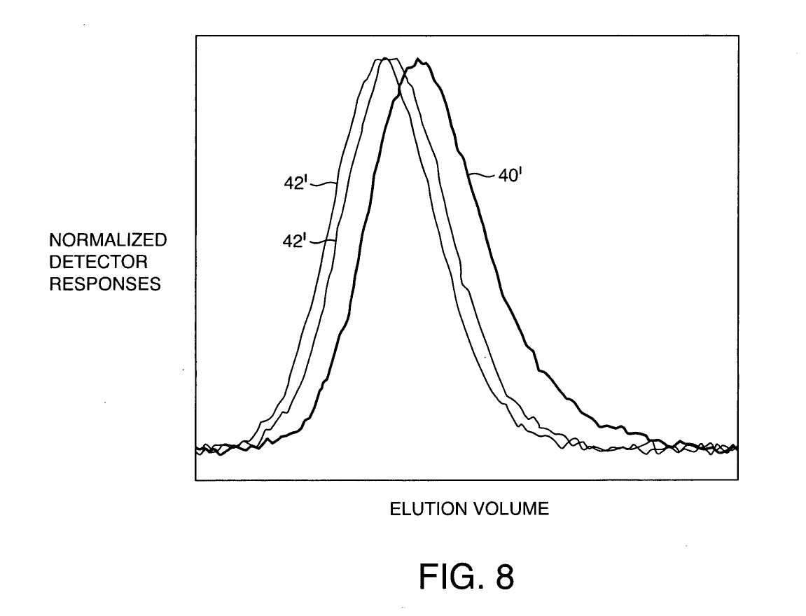

FIG. 7 shows the detector profiles based on the instrumental responses to the concentration profile described in FIG. 6A. To complete the simulation, the appropriate level of detector noise to is added to each of the simulated signals. Detector noise is simulated by adding to each point in each profile zero-mean random Gaussian deviates with standard deviations chosen to approximate typical detector performance. FIG. 8 shows the profiles after the addition of the baseline noise to each of the detector responses. Shown in FIG. 8 are the RI 40, LS 42 and V44 detector responses.

In general, minimization procedures described above require that initial parameters values be found and that an initial value for χ² be computed. These parameters are then iteratively adjusted until the minimum of χ² is found.

In the formulations of χ² discussed above, the determination of initial parameter values can be accomplished by a variety of standard methods. Such methods include the manual estimation of values that are known to approximate the expected final parameter values; the adoption of typical values of parameters; or the implementation of a separate algorithm that determines initial parameters values from a subset of the data to be analyzed.

In the formulations of χ² discussed above, the subsequent iterative adjustment of the parameters can be accomplished by a variety of standard methods. Methods that find the minimum of a function of N-variables include Newton-Raphson, Levenberg-Marquadt, simplex, gradient search, and brute force search. Such iterative adjustment procedures are described in the Numerical Recipes in C, The Art of Scientific Computing, Second Edition, (1992) W. H. Press, S. A. Teukolsky, W. T. Vetterling, B. P. Flannery, Univ. of Cambridge, pages 394-455.

While specific examples of RI, V and LS detectors are described in the embodiments, herein, it will be appreciated that other detectors, such as other models and/or from other manufactures, can be implemented.

Although the invention has been shown and described with respect of exemplary embodiments thereof, various other changes, omissions and additions in the form and detail thereof may be made therein without departing from the spirit and cope of the invention.

1. On a computer system, a method of determining radius of gyration distribution of a sample processed using gel permeation chromatography apparatus, said method comprising the steps of:
obtaining data from a detector detecting data from at least two channels of a sample;
obtaining a parameterized model describing sample properties;
choosing initial values for parameters from said parameterized model;
constructing an initial curve from said data, from said parameterized model, and from said initial values; and
determining a best fit curve and best fit parameter values from said initial curve and from said parameterized model to determine said radius of gyration distribution.

2. The method according to claim 1 wherein, said detector is a multi-angle laser light scatter detector.

3. The method according to claim 1 wherein, said parameterized model fit simultaneously all data collected and said simultaneously use of all data improves the estimate of the radius of gyration

4. On a computer system, a method of determining the conformation law of a sample processed by gel permeation chromatography, said method comprising the steps of:
obtaining data from a detector detecting data from at least two channels of a sample;
obtaining a parameterized model describing sample properties;
choosing initial valves for parameters from said parameterized model;
constructing an initial curve from said data, from said parameterized model, and from said initial values;
determining a best fit curve and best fit parameter values from said initial curve and from said parameterized model to determine said radius of gyration distribution;
obtaining second data from a second detector detecting said sample; and
determining a best fit curve and best fit parameter values from said initial curve, from said parameterized model and from said second data to provide a MWD of said sample thereby determining the conformation law of said sample.

5. The method according to claim 4 wherein said first detector is a multi-angle light scattering detector.

6. The method according to claim 4 wherein said second detector measures a peak's concentration profile and is selected from a group consisting of RI detector, UV absorbance detector, evaporative light scattering detector and an infrared detector.

7. On a computer system, a method of determining the IVL of a sample processed by gel permeation chromatography, said method comprising the steps of:
obtaining first data from a first detector detecting said sample;
obtaining a parameterized model describing log intrinsic viscosity versus log molecular weight;
choosing initial values for parameters for said parameterized model;
obtaining hydrodynamic volume of slices from a universal calibration curve;
constructing an initial curve of specific viscosity from said first data, from said parameterized model, from said initial values, and from said hydrodynamic volume of slices;
obtaining second data from a second detector detecting at least two channels from said sample; and
determining a best fit curve of specific viscosity and best fit parameter values of said model of log intrinsic viscosity versus log molecular weight from said initial curve, from said second parameterized model, and from said second data; and
determining IVL from said parameterized model and said best fit parameter.

8. The method of claim 7 wherein said first detector includes a concentration sensitive detector.

9. The method of claim 8 wherein said second detector includes a multi-angle light scattering detector.

10. On a computer system, a method of determining radius of gyration, conformational law, molecular weight distribution, intrinsic viscosity and the column calibration of a sample processed by gel permeation chromatography, said method comprising the steps of:
obtaining first data from a first detector detecting said sample;
obtaining a parameterized model describing log intrinsic viscosity versus log molecular weight;
choosing initial values for parameters for said parameterized model;
obtaining hydrodynamic volume of slices from a universal calibration curve;
constructing an initial curve of specific viscosity from said first data, from said parameterized model, from said initial values, and from said hydrodynamic volume of slices;
obtaining second data from a second detector detecting at least two channels from said sample;
obtaining third data from a third detector detecting concentration of said sample; and
determining a best fit curve of specific viscosity and best fit parameter values of said model of log intrinsic viscosity versus log molecular weight from said initial curve, from said second parameterized model, from said second data and from said third data; and
determining the radius of gyration, IVL, conformational law, intrinsic viscosity and column calibration from said parameterized model and said best fit parameter.

11. The method of claim 10 wherein said first detector includes a viscometer detector.

12. The method of claim 10 wherein said second detector includes a multi-angle light scattering detector.

13. The method according to claim 10 wherein said third detector measures a peak's concentration profile and is selected from a group consisting of RI detector, UV absorbance detector, evaporative light scattering detector and an infrared detector.
